(19) United States
(12) Patent Application Publication
(10) Pub. No.: US 2021/0020995 A1
(43) Pub. Date: Jan. 21, 2021

(54) SOLID-STATE BATTERY

(71) Applicant: HONDA MOTOR CO., LTD., Tokyo (JP)

(72) Inventors: Masahiro OHTA, Saitama (JP); Takuya TANIUCHI, Saitama (JP)

(21) Appl. No.: 17/042,199

(22) PCT Filed: Mar. 25, 2019
(86) PCT No.: PCT/JP2019/012554

§ 371 Date: Sep. 28, 2020

(30) Foreign Application Priority Data
Mar. 30, 2018 (JP) 2018-067612

(51) Int. Cl. H01M 10/0585; H01M 2/10; H01M 10/0525

(52) U.S. Cl. CPC H01M 10/0585; H01M 10/0525; H01M 2/1061

(57) ABSTRACT

Provided is a solid-state battery that makes it possible to minimize the occurrence of cracks in layers constituting the solid-state battery even when there is variation in the thicknesses of the individual layers. The solid-state battery is provided with a plurality of solid-state battery cells each provided with a positive electrode layer, a negative electrode layer, and a solid electrolyte layer sandwiched between the positive electrode layer and the negative electrode layer. The solid-state battery is additionally provided with a stress relaxation layer for relaxing stress applied to the solid-state battery. The flatness tolerance of the stress relaxation layer-side surface of another layer in contact with the stress relaxation layer is 100 μm or more and/or the parallelism tolerance of the stress relaxation layer-side surface of another layer in contact with the stress relaxation layer is 100 μm or more.

### TECHNICAL FIELD

The present invention relates to a solid-state battery.

### BACKGROUND ART

As electric and electronic products that vary in size, such as vehicles, personal computers, and mobile phones, have been spreading widely in recent years, the demands of high voltage or high capacity batteries have been quickly expanding. For example, solid-state batteries each including a solid electrolyte have received attention recently, because the batteries are superior in terms of safety as the electrolyte is incombustible, and in terms of higher energy density, compared with batteries each including a conventional electrolyte, i.e., an organic electrolytic solution (for example, see Japanese Unexamined Patent Application, Publication No. 2014-026747).

On the other hand, solid-state batteries each including a solid electrolyte layer are susceptible to external shocks, because the batteries each have an all-solid layered body. Since an electrode active material expands and contracts as a solid-state battery undergoes charging and discharging, stress is often applied to layers constituting the solid-state battery.

Techniques that improve the durability of a solid-state battery have thus been disclosed. For example, Japanese Unexamined Patent Application/Publication No. 2010-106252 discloses a technique regarding a lithium battery including a solid electrolyte layer manufactured by using polarized diene-based polymeric slurry. Japanese Unexamined Patent Application, Publication No. 2010-106252 describes that the mechanical strength of the solid electrolyte layer in the lithium battery can be improved against shocks, for example.

Patent Document 1: Japanese Unexamined Patent Application, Publication No. 2014-026747

Patent Document 2: Japanese Unexamined Patent Application, Publication Mo. 2010-106252

### DISCLOSURE OF THE INVENTION

### Problems to be Solved by the Invention

The thickness of the layers constituting a solid-state battery may not be constant, but may vary. For example, an electrode sheet constituting an electrode layer may become increasingly thicker or thinner towards the center in the in-plane direction.

Therefore, when there is variation in the thickness of each of such layers, and when there are external shocks or when an electrode active material expands and contracts as a solid-state battery undergoes charging and discharging, stress may concentrate at a thicker portion of each of the layers, leading to cracks due to strain accumulated in the layers constituting the solid-state battery. When there is variation in the thickness of each of the layers, the solid-state battery can be discarded. Discarding the solid-state battery, which leads to a lowered yield rate, is not preferable in terms of productivity.

In particular, in a case where a battery has been multi-layered to give high voltage or high capacity characteristics, cracks are likely to occur due to strain particularly likely to be accumulated in the layers constituting the solid-state battery.

An object of the present invention is to provide a solid-state battery capable, even when there is variation in the thickness of layers constituting the solid-state battery, of suppressing cracks from occurring in the layers.

### Means for Solving the Problems

As a result of proactive reviews to solve the problems described above, the inventors have found that a solid-state battery including a stress relaxation layer that relaxes stress applied to layers constituting the solid-state battery can solve the problems described above, and have completed the present invention.

The present invention provides a solid-state battery including a plurality of solid-state battery cells each including a positive electrode layer, a negative electrode layer, and a solid electrolyte layer sandwiched between the positive electrode layer and the negative electrode layer. The solid-state battery includes a stress relaxation layer that relaxes stress applied to the solid-state battery. A flatness tolerance of a surface of one of the layers, the surface facing the stress relaxation layer, the other one of the layers being in contact with the stress relaxation layer, is equal to or greater than 100 μm, and/or a parallelism tolerance of the surface of the other one of the layers, the surface facing the stress relaxation layer, the other one of the layers being in contact with the stress relaxation layer, is equal to or greater than 100 μm.

Therefore, stress applied to the layers constituting the solid-state battery can be relaxed, effectively suppressing cracks from occurring.

The stress relaxation layer may include resin.

At least one of the positive electrode layer, the solid electrolyte layer, or the negative electrode layer may serve as the stress relaxation layer.

The stress relaxation layer may be disposed between the plurality of solid-state battery cells.

An exterior body at least partially covering an exterior of the solid-state battery may be further included. Stress relaxation layers that relax stress applied to the solid-state battery may be further disposed between the solid-state battery cells and the exterior body.

The stress relaxation layer may be disposed at least either of between the positive electrode layer and the solid electrolyte layer or between the negative electrode layer and the solid electrolyte layer.

### Effects of the Invention

According to the present invention, even when there is variation in the thickness of each of layers constituting a solid-state battery, it is possible to effectively suppress cracks from occurring in the layers.

### BRIEF DESCRIPTION OF THE DRAWINGS

FIG. 1 is a cross-sectional view of a solid-state battery 1 according to a first embodiment of the present invention;

FIG. 2 is a cross-sectional view of a solid-state battery 2 according to a second embodiment of the present invention;

FIG. 3 is a cross-sectional view of a solid-state battery 3 according to a third embodiment of the present invention;

FIG. 4 is a cross-sectional view of a solid-state battery 4 according to a fourth embodiment of the present invention; and

FIG. 5 is a cross-sectional view of a solid-state battery 5 according to a fifth embodiment of the present invention.

### PREFERRED MODE FOR CARRYING OUT THE INVENTION

Specific embodiments of the present invention will now be described in detail. However, the present invention is not limited to the embodiments described below, but can be appropriately changed and implemented within the scope of the present invention.

<Solid-State Battery According to First Embodiment>

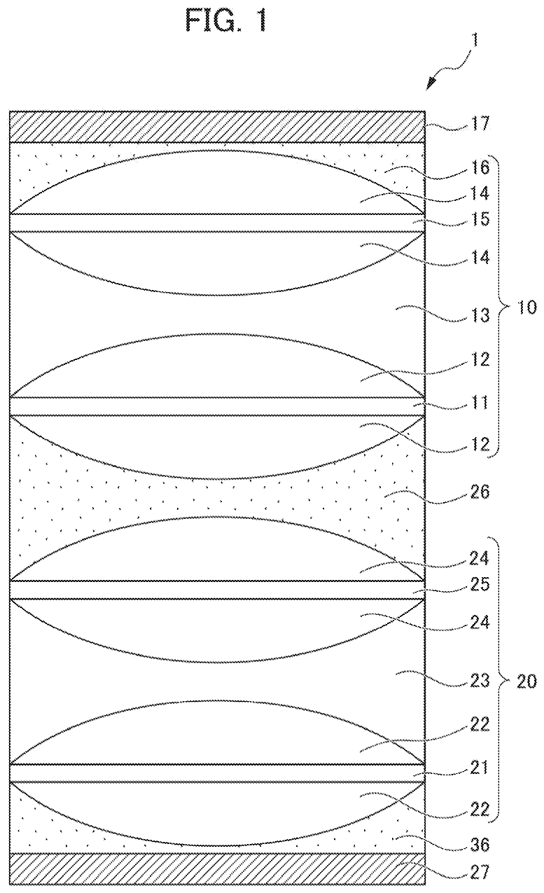

FIG. 1 is a cross-sectional view of a solid-state battery 1 according to a present embodiment. The solid-state battery 1 according to the present embodiment is the solid-state battery 1 including a plurality of solid-state battery cells 10 and 20 respectively including positive electrode layers 12 and 22, negative electrode layers 14 and 24, and solid electrolyte layers 13 and 23 respectively sandwiched between the positive electrode layers and the negative electrode layers.

More specifically, the solid-state battery 1 according to the present embodiment includes the solid-state battery cells 10 and 20 respectively including positive electrode current collector layers 11 and 21, the positive electrode layers 12 and 22, the solid electrolyte layers 13 and 23, the negative electrode layers 14 and 24, negative electrode current collector layers 15 and 25, and support bodies 17 and 27 covering an exterior of the solid-state battery 1.

In the solid-state battery 1 according to the present embodiment, the positive electrode layers 12 and 22 and the negative electrode layers 14 and 24 are each formed increasingly thicker towards the center in a surface direction, i.e., the thicknesses of the layers vary. More specifically, the positive electrode layers 12 and 22 and the negative electrode layers 14 and 24 each represent a layer where a flatness tolerance of a surface facing each of the stress relaxation layers is equal to or greater than 100 μm. Therefore, when there are external shocks or when an electrode active material expands and contracts as the solid-state battery undergoes charging and discharging, cracks easily occur due to strain accumulated in the layers constituting the solid-state battery.

The solid-state battery 1 according to the present embodiment is formed so that the solid electrolyte layers 13 and 23 function as stress relaxation layers that relax stress applied to the solid-state battery. Specifically, the solid electrolyte layers 13 and 23 are characterized to be each formed increasingly thinner towards the center in the surface direction. Therefore, since stress can be prevented from concentrating at the thicker portions of the positive electrode layers 12 and 22 and the negative electrode layers 14 and 24, stress applied to the layers constituting the solid-state battery can be relaxed, effectively suppressing cracks from occurring.

Between the support body 17 and the solid-state battery cell 10, between the support body 27 and the solid-state battery cell 20, and between the solid-state battery cell 10 and the solid-state battery cell 20, stress relaxation layers 16, 26, and 36 that relax stress applied to the solid-state battery are further disposed. In the embodiment, the stress relaxation layers 16, 26, and 36 are each formed increasingly thinner towards the center in the surface direction, similar to the solid electrolyte layers 13 and 23. Therefore, stress applied to the layers constituting the solid-state battery can be relaxed, more effectively suppressing cracks from occurring.

As described above, layers constituting a solid-state battery cell, such as a positive electrode layer, a solid electrolyte layer, and a negative electrode layer may serve as the stress relaxation layers, as long as the thickness of the layers vary so that respective surfaces are in close contact with other layers (the solid electrolyte layers 13 and 23). Other layers than the layers constituting the solid-state battery cell (the stress relaxation layers 16, 26, and 36) may otherwise serve as the stress relaxation layers. Note that, in the embodiment, the stress relaxation layer 26 further serves as an insulation layer that controls electrode reactions in the solid-state battery cells 10 and 20.

Note that, although the solid-state battery 1 according to the present embodiment is a solid-state battery where the solid electrolyte layers serve as the stress relaxation layers, solid-state batteries according to the present invention are not limited to such an aspect that a solid electrolyte layer serves as a stress relaxation layer, but, for example, a positive electrode layer, a negative electrode layer, or another layer may serve as a stress relaxation layer.

Components of the solid-state battery 1 according to the present embodiment will be described below.

[Positive Electrode Layer]

A positive electrode layer represents a layer including at least a positive electrode active material. It is sufficient that, as the positive electrode active material, a material that can discharge and absorb ions (for example, lithium ions) be appropriately selected and used. In terms of improving ionic conductivity (for example, lithium ionic conductivity), a solid electrolyte may be optionally included. To improve electric conductivity, an electric-conductive auxiliary agent may be optionally included. Furthermore, in terms of imparting flexibility, for example, a binder may be optionally included. Those that are ordinarily used in a solid-state battery may be used as a solid electrolyte, an electric-conductive auxiliary agent, and a binder.

The positive electrode active material can be similar to, but is not particularly limited to, one that is used as a positive electrode active material in an ordinary solid-state battery. Examples of the positive electrode active material can include, for example, layered active materials, spinel type active materials, and olivine type active materials respectively including lithium. Specific examples of the positive electrode active material include, for example, lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganese oxide (LiMn₂O₄), different kinds of elemental substituted Li—Mn spinels represented by Li₁+xMn_{2-x-y}M_{y}O₄ (x+y=2, M=at least one type selected from a group consisting of Al, Mg, Co, Fe, Mi, and Zn), and lithium metal phosphate (LiMPO₄, M=at least one type selected from a group consisting of Fe, Mn, Co, and Ni).

[Positive Electrode Current Collector Layer]

A positive electrode current collector layer is not particularly limited, as long as the layer has the functionality of performing current collection in a positive electrode layer, and is made of, for example, aluminum, aluminum alloy, stainless steel, nickel, iron, or titanium, and preferably aluminum, aluminum alloy, or stainless steel. For example, a positive electrode current collector can be in the form of foil, plate, or mesh.

(Method of Manufacturing a Positive Electrode Layer)

A positive electrode can be manufactured by disposing a positive electrode mixture including a positive electrode active material on a surface of a positive electrode current collector. As the method of manufacturing a positive electrode, a method similar to a conventional method can be used. A positive electrode can be manufactured with either a wet method or a dry method. A case where a positive electrode is manufactured with a wet method will be described below.

A positive electrode layer is manufactured through a process of acquiring a positive electrode mixture paste including a positive electrode mixture and a solvent, and a process of applying the positive electrode mixture paste onto a surface of a positive electrode current collector layer, and of allowing the positive electrode mixture paste to dry to form a positive electrode layer on the surface of the positive electrode current collector layer. For example, the positive electrode mixture paste can be acquired by mixing and dispersing the positive electrode mixture in the solvent. The solvent used in this case Is not particularly limited, but may be appropriately selected in accordance with characteristics of a positive electrode active material or a solid electrolyte, for example. For example, a non-polar solvent such as heptane is preferable. To mix and disperse a positive electrode mixture in a solvent, one of a variety of mixing and dispersing devices can be used, such as an ultrasonic dispersion device, a shaker, or a FILMIX (registered trademark). A solid component amount in a positive electrode mixture paste is not particularly limited.

The positive electrode layer can be manufactured by applying the positive electrode mixture paste acquired as described above onto a surface of a positive electrode current collector layer, and allowing the positive electrode mixture paste to dry to form a positive electrode mixture layer on the surface of the positive electrode current collector layer. As means of applying a positive electrode paste onto a surface of a positive electrode current collector layer, known application means may be used, such as a doctor blade.

A total thickness of the positive electrode layer and the positive electrode current collector layer after drying (a thickness of the positive electrode) is not particularly limited, but is preferably equal to or greater than 0.1 μm, and is more preferably equal to or greater than 1 μm, in terms of energy density and ease of lamination, for example. A total thickness of a positive electrode mixture layer and a positive electrode current collector after drying (the thickness of the positive electrode) is preferably equal to or below 1 mm, and is more preferably equal to or below 100 μm, in terms of energy density and ease of lamination, for example. A positive electrode layer and a positive electrode current collector layer may be optionally manufactured through pressing. When the positive electrode layer and the positive electrode current collector layer undergo pressing, the pressure can be approximately 100 MPa.

[Negative Electrode Layer]

A negative electrode layer represents a layer including at least a negative electrode active material. In terms of improving ionic conductivity, a solid electrolyte may be optionally included. To improve electric conductivity, an electric-conductive auxiliary agent may be optionally included. Furthermore, in terms of causing exhibiting flexibility, for example, a binder may be optionally included. Those that are ordinarily used in a solid-state battery may be used as a solid electrolyte, an electric-conductive auxiliary agent, and a binder.

The negative electrode active material may be, but is not particularly limited to, one that can absorb and discharge ions (for example, lithium ions). Examples of the negative electrode active material can include, for example, lithium transition metal oxides such as lithium titanate (Li₄Ti₅O₁₂), transition metal oxides such as TiO₂, Nb₂O₃, and WO₃, metallic sulfides, metallic nitrides, carbon materials such as graphite, soft carbon, and hard carbon, metallic lithium, metallic indium, and lithium alloys. The negative electrode active material may be in the form of powder or thin film.

[Negative Electrode Current Collector Layer]

A negative electrode current collector layer is not particularly limited, as long as the layer has the functionality of performing current collection in a negative electrode layer. Example materials of a negative electrode current collector can include, for example, nickel, copper, and stainless steel. For example, a negative electrode current collector can be in the form of foil, plate, or mesh.

(Method of Manufacturing a Negative Electrode)

Similarly to the positive electrode, a negative electrode can be manufactured by, for example, loading a negative electrode active material into a solvent, using an ultrasonic dispersion device, for example, to allow the negative electrode active material to disperse to manufacture a negative electrode mixture paste, and applying the negative electrode mixture paste onto a surface of a negative electrode current collector layer and then allowing the negative electrode mixture paste to dry. The solvent used in this case is not particularly limited, but may be appropriately selected in accordance with the characteristics of a negative electrode active material, for example.

A total thickness of the negative electrode layer and the negative electrode current collector layer after drying (a thickness of a negative electrode) is, for example, preferably equal to or greater than 0.1 μm, and is more preferably equal to or greater than 1 μm. The thickness of the negative electrode is, for example, preferably equal to or below 1 mm, and is more preferably equal to or below 100 μm. The negative electrode can be manufactured through pressing. When the negative electrode undergoes pressing/ the pressure is preferably equal to or greater than 200 MPa, and is more preferably approximately 400 MPa.

[Solid Electrolyte Layer]

A solid electrolyte layer represents a layer laminated between a positive electrode layer and a negative electrode layer, and represents a layer including at least a solid electrolyte material. Lithium ion conduction between a positive electrode active material and a negative electrode active material can be achieved via the solid electrolyte material included in the solid electrolyte layer.

The solid electrolyte material is not particularly limited, as long as the material has ionic conductivity (for example, lithium ionic conductivity). Examples of the solid electrolyte material can include, for example, sulfide solid electrolyte materials, oxide solid electrolyte materials, nitride solid electrolyte materials, and halide solid electrolyte materials. Among the materials described above, a sulfide solid electrolyte material is preferable. One reason is its higher lithium ionic conductivity, compared with an oxide solid electrolyte material.

Examples of the sulfide solid electrolyte materials include, for example, Li₂S—P₂S₅ and Li₂S—P₂S₅—LiI. Note that, “Li₂S—P₂S₅” described above means sulfide solid electrolyte materials each including a raw material composition including Li₂S and P₂S₅. The meaning is similarly applicable to other descriptions.

On the other hand, examples of the oxide solid electrolyte materials can include, for example, NASICON-type oxides, garnet-type oxides, and perovskite-type oxides. Examples of the NASICON-type oxides can include, for example, oxides including Li, Al, Ti, P, and O (for example, Li_{1.5}Al_{0.5}Ti_{1.5}(PO₄)₃). Examples of the garnet-type oxides can include, for example, oxides including Li, La, Zr, and O (for example, Li₂La₃Zr₂O₁₂). Examples of the perovskite-type oxides can include, for example, oxides including Li, La, Ti, and O (for example, LiLaTiO₃).

(Method of Manufacturing a Solid Electrolyte Layer)

A solid electrolyte layer can be manufactured through processing including pressing of a solid electrolyte, for example. Otherwise, for example, a solid electrolyte layer can be manufactured by applying a solid electrolyte paste where a solid electrolyte is dispersed and adjusted in a solvent onto a surface of a base material or an electrode. The solvent used in this case is not particularly limited, but may be appropriately selected in accordance with characteristics of a binder or a solid electrolyte, for example.

A thickness of the solid electrolyte layer greatly varies depending on a configuration of a battery, for example, but is preferably equal to or greater than 0.1 μm, and is more preferably equal to or greater than 1 μm. The thickness of the solid electrolyte layer is, for example, preferably equal to or below 1 mm, and is more preferably equal to or below 100 μm.

[Stress Relaxation Layer]

A stress relaxation layer represents a layer that relaxes stress applied when there are external, shocks or when an electrode active material expands and contracts as a solid-state battery undergoes charging and discharging to suppress cracks from occurring in layers constituting the solid-state battery.

The stress relaxation layer is not particularly limited, as long as the layer can relax stress applied to layers constituting a solid-state battery to suppress cracks from occurring.

The stress relaxation layer preferably includes resin. In a case where a stress relaxation layer includes resin, flexibility can be imparted, more effectively relaxing stress. Examples of the resin included in the stress relaxation layer can include, for example, polyvinylidene fluoride (PVDF), styrene butadiene rubber (SBR), carboxymethyl cellulose (CMC), polytetrafluoroethylene (PTFE), acrylic-based resin or polyimide-based resin, and other kinds of resin.

A thickness of the stress relaxation layer is not particularly limited, but is, for example, preferably equal to or greater than 1 μm, and is more preferably equal to or greater than 100 μm. In a case where the thickness of the stress relaxation layer is equal to or greater than 1 μm, stress applied to layers constituting a solid-state battery can be relaxed, more effectively suppressing cracks from occurring. An upper limit of the thickness of the stress relaxation layer is not particularly limited, but is preferably, for example, equal to or below 1000 μm.

Note that another layer other than the layers constituting a solid-state battery cell, or one of the layers constituting the solid-state battery cell (for example, a positive electrode layer, a solid electrolyte layer, or a negative electrode layer) may serve as a stress relaxation layer. For example, the stress relaxation layer may further serve as an insulation layer that controls electrode reactions in the solid-state battery cell (for example, the stress relaxation layer 26 in FIG. 1). Furthermore, in a case where a stress relaxation layer is to be disposed between a positive electrode layer and a solid electrolyte layer or between a negative electrode layer and the solid electrolyte layer, the stress relaxation layer may include a solid electrolyte material so as to have electric conductivity.

The solid-state battery according to the present embodiment includes a stress relaxation layer that relaxes stress accumulated in each of the layers. The stress relaxation layer and one of the layers, which has a thickness that greatly varies, are disposed in contact with each other. One of the layers, which has a thickness that greatly varies, specifically refers to a layer where a flatness tolerance of a surface, which faces the stress relaxation layer, of the layer in contact with the stress relaxation layer, is equal to or greater than 100 μm, and/or a parallelism tolerance of the surface, which faces the stress relaxation layer, of the layer in contact with the stress relaxation layer, is equal to or greater than 100 μm. The layer can thus relax stress applied to the layers constituting the solid-state battery, more effectively suppressing cracks from occurring.

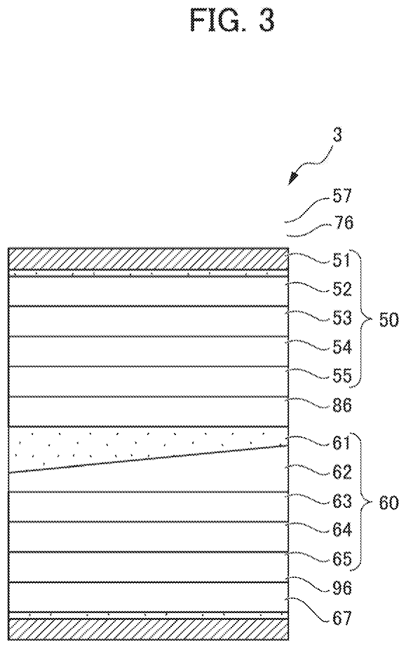

Note that the flatness tolerance can be acquired with the method specified in JIS B0021: 1998. The parallelism tolerance means the difference between maximum and minimum heights of a surface of one (for: example, a positive electrode current collector layer 61 in FIG. 3) of the layers in contact with the stress relaxation layer, which are determined using as a reference, a stress relaxation layer-facing surface of the other layer (for example, a negative electrode current collector layer 55 in FIG. 3). A flatness tolerance and a parallelism tolerance can be measured with, for example, a three-dimensional (shape) measuring device.

(Method of Manufacturing a Stress Relaxation Layer)

A method of manufacturing a stress relaxation layer may be, for example, one where a resin exemplified as described above is laminated via an adhesive to form a layer, or one where a resin is laminated with an extrusion coating method, for example.

Such an aspect may also be applied that the method described above is used to measure a flatness tolerance of a surface of each of the layers constituting a solid-state battery, and then a stress relaxation layer is laminated with the method described above on one of the surfaces, where the flatness tolerance is equal to or greater than 100 μm. Therefore, a flatness tolerance of a surface, which faces the stress relaxation layer, of another layer in contact with the stress relaxation layer becomes equal to or greater than 100 μm. Stress applied to the layers constituting the solid-state battery can thus be relaxed, effectively suppressing cracks from occurring.

[Support Body]

Support bodies 17 and 27 each have the functionality of at least partially covering the exterior of the solid-state battery 1, protecting the solid-state battery 1 from external shocks.

A material of the support bodies is not particularly limited, but is preferably a rigid material. Examples of the material include, for example, resin based on polyethylene terephthalate, polyethylene naphthalate, nylon, or polypropylene, rubber such as natural rubber and silicone rubber, metals such as stainless steel and aluminum (including alloys), and ceramics. Note that, in a case where the support bodies are made of rubber, external shocks can be effectively absorbed, and electrodes can be securely held under its higher frictional coefficient.

<Solid-State Battery According to Second Embodiment>

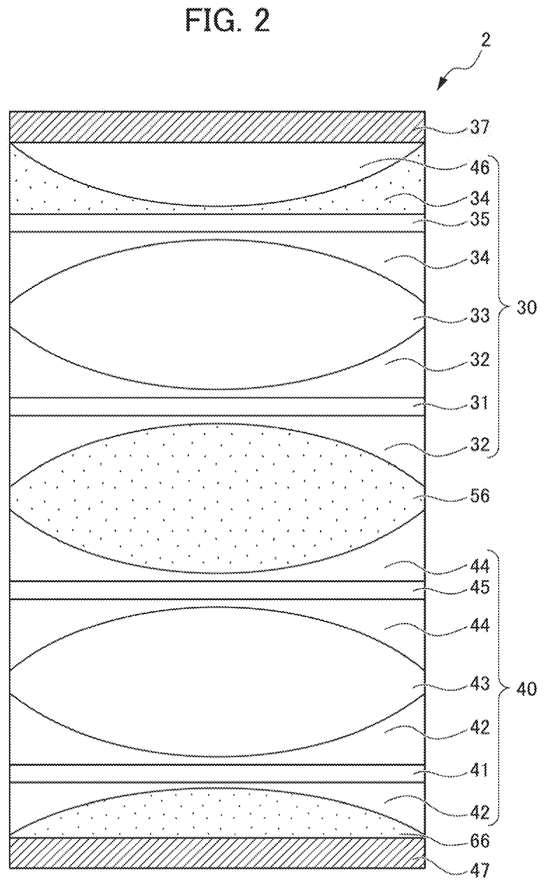

Next, a solid-state battery according to another embodiment, which differs from the solid-state battery 1 according to the embodiment described above, will be described with reference to FIG. 2. Note that components common to the components of the solid-state battery 1 according to the embodiment described above are appropriately omitted.

FIG. 2 is a cross-sectional view of a solid-state battery 2 according to the present embodiment. The solid-state battery 2 includes two solid-state battery cells 30 and 40 each including a positive electrode current collector layer, a positive electrode layer, a solid electrolyte layer, a negative electrode layer, and a negative electrode current collector layer. Positive electrode layers 32 and 42 and negative electrode layers 34 and 44 are each formed increasingly thinner towards the center in the surface direction. A flatness tolerance of a surface facing the stress relaxation layer is equal to or greater than 100 μm. Therefore, when there are external shocks or when an electrode active material expands and contracts as the solid-state battery undergoes charging and discharging, cracks easily occur due to strain accumulated in the layers constituting the solid-state battery.

The solid-state battery 2 according to the present embodiment is characterized in that solid electrolyte layers 33 and 43 are each formed increasingly thicker towards the center in the surface direction. Furthermore, between a support body 37 and the solid-state battery cell 30, between a support body 47 and the solid-state battery cell 40, and between the solid-state battery cell 30 and the solid-state battery cell 40, respectively, stress relaxation layers 46, 56, and 66 that relax stress applied to the solid-state battery are further disposed. The stress relaxation layers 46, 56, and 66 are, similar to the solid electrolyte layers 33 and 43, each formed increasingly thicker towards the center in the surface direction. Therefore, stress applied to the layers constituting the solid-state battery can be relaxed, more effectively suppressing cracks from occurring. Note that, in the embodiment, the stress relaxation layer 56 further serves as an insulation layer that controls electrode reactions in the solid-state battery cells 30 and 40.

<Solid-State Battery According to Third Embodiment>

Next, a solid-state battery according to another embodiment, which differs from the solid-state battery 1 according to the embodiment described above, will be described with reference to FIG. 3. Note that components common to the components of the solid-state battery 1 according to the embodiment described above are appropriately omitted.

FIG. 3 is a cross-sectional view of a solid-state battery 3 according to the present embodiment. The solid-state battery 3 according to the present embodiment is a solid-state battery where a layer constituting a solid-state battery cell 60 is inclined, and thus, in a relationship with a solid-state battery cell 50, a parallelism tolerance of a surface is equal to or greater than 100 μm. The solid-state battery 3 according to the present embodiment is characterized in that a stress relaxation layer 86 is also inclined in accordance with the inclination of the solid-state battery cell 60 so that a whole thickness of the solid-state battery 3 is constant. Therefore, since stress can be prevented from concentrating at thicker portions of the layers, stress applied to the layers constituting the solid-state battery can be relaxed, effectively suppressing cracks from occurring. Note that, in the embodiment, the stress relaxation layer 86 further serves as an insulation layer that controls electrode reactions in the solid-state battery cells 50 and 60.

Note that, to configure a stress relaxation layer so that surfaces of layers in contact with each other are inclined to each other, for example, it is sufficient that, after the solid-state battery cells are produced, thicknesses at the centers and ends of the whole solid-state battery cells be measured, and then a thickness of the stress relaxation layer to be formed be adjusted in accordance with the thicknesses.

<Solid-State Battery According to Fourth Embodiment>

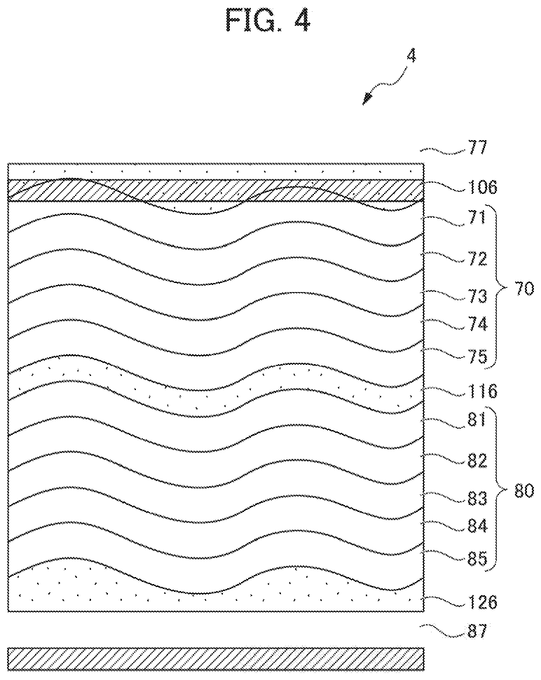

Next, a solid-state battery according to another embodiment, which differs from the solid-state battery 1 according to the embodiment described above, will be described with reference to FIG. 4. Note that components common to the components of the solid-state battery 1 according to the embodiment described above are appropriately omitted.

FIG. 4 is a cross-sectional view of a solid-state battery 4 according to the present embodiment. The solid-state battery 4 according to the present embodiment is a solid-state battery where the thicknesses of the layers constituting solid-state battery cells 70 and 80 vary so that a flatness tolerance of a surface is equal to or greater than 100 μm. The solid-state battery 4 according to the present embodiment includes the two solid-state battery cells 70 and 80 each including a positive electrode current collector layer, a positive electrode layer, a solid electrolyte layer, a negative electrode layer, and a negative electrode current collector layer, and is characterized in that a thickness of a stress relaxation layer 106 varies in accordance with the thicknesses of other layers that are in contact with each other, i.e., a negative electrode current collector layer 75 and a positive electrode current collector layer 31, so that a whole thickness of the solid-state battery A is constant. Note that, in the embodiment, a stress relaxation layer 116 further serves as an insulation layer that controls electrode reactions in the solid-state battery cells 70 and 80. Since stress can be prevented from concentrating at thicker portions of the layers, stress applied to the layers constituting the solid-state battery can be relaxed, effectively suppressing cracks from occurring.

<Solid-State Battery According to Fifth Embodiment>

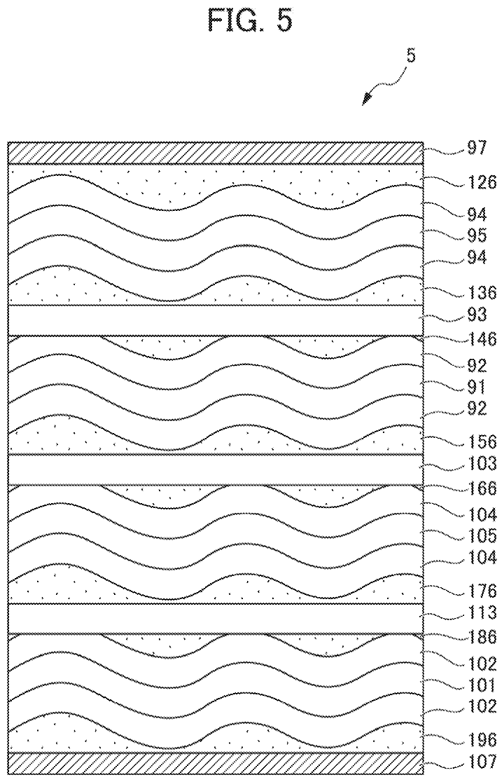

Next, a solid-state battery according to another embodiment, which differs from the solid-state battery 1 according to the embodiment described above, will be described with reference to FIG. 5. Note that components common to the components of the solid-state battery 1 according to the embodiment described above are appropriately omitted.

FIG. 5 is a cross-sectional view of a solid-state battery 5 according to the present embodiment. The solid-state battery 5 is characterized in that no insulation layer is provided, but pluralities of positive electrode layers, solid electrolyte layers, and negative electrode layers are respectively alternately laminated with each other. Between solid electrolyte layers 93, 103, and 113 and positive electrode layers 92 and 102 or negative electrode layers 94 and 104, stress relaxation layers 136, 146, 156, 166, 176, and 186 are then respectively disposed.

Since stress can be prevented from concentrating at thicker portions of the stress relaxation layers 136, 146, 156, 166, 176, and 186, stress applied to the layers constituting the solid-state battery can be relaxed, effectively suppressing cracks from occurring.

Note that, to have electric conductivity between a positive electrode layer and a solid electrolyte layer, or between a negative electrode layer and a solid electrolyte layer, a stress relaxation layer preferably includes a solid electrolyte material.

Note that, it is sufficient that a thickness of a stress relaxation layer be varied so that stress applied to layers constituting a solid-state battery can be relaxed, suppressing cracks from occurring. For example, it is not necessary that a stress relaxation layer be disposed on a whole surface of another layer that is in contact with each other. Such an aspect may be applied that a stress relaxation layer is disposed at least partially on a surface of another layer that is in contact with each other.

As described above, the solid-state batteries according to the present invention can relax stress applied to the layers constituting the solid-state batteries, effectively suppressing cracks from occurring.

### EXPLANATION OF REFERENCE NUMERALS

1, 2, 3, 4, 5 Solid-state battery
10, 20, 30, 40, 50, 60, 70, 30 Solid-state battery cell
11, 21, 31, 41, 51, 61, 71, 81, 91, 101 Positive electrode current collector layer
12, 22, 32, 42, 52, 62, 72, 82, 92, 102 Positive electrode layer
13, 23, 33, 43, 53, 63, 73, 83, 93, 103, 113 Solid electrolyte layer
14, 24, 34, 44, 54, 64, 74, 84, 94, 104 Negative electrode layer
15, 25, 35, 45, 55, 65, 75, 85, 95, 105 Negative electrode current collector layer
16, 26, 36, 46, 56, 66, 76, 86, 96, 106, 116, 126 Stress relaxation layer
17, 27, 37, 47, 57, 67, 77, 87, 97, 107 Support body

1. A solid-state battery including a plurality of solid-state battery cells having an all-solid layered body, the plurality of solid-state battery cells each including a positive electrode layer, a negative electrode layer, and a solid electrolyte layer sandwiched between the positive electrode layer and the negative electrode layer, the solid-state battery comprising
a stress relaxation layer that relaxes stress applied to the solid-state battery,
wherein a flatness tolerance of a surface of one of the layers, the surface facing the stress relaxation layer, the one of the layers being in contact with the stress relaxation layer, is equal to or greater than 100 μm, and/or a parallelism tolerance of the surface of the one of the layers, the surface facing the stress relaxation layer, the one of the layers being in contact with the stress relaxation layer, is equal to or greater than 100 μm.

2. The solid-state battery according to claim 1, wherein the stress relaxation layer includes resin.

3. The solid-state battery according to claim 1 or 2, wherein at least one of the positive electrode layer, the solid electrolyte layer, or the negative electrode layer constitutes the stress relaxation layer.

4. The solid-state battery according to any one of claims 1 to 3, wherein the stress relaxation layer is disposed between the plurality of solid-state battery cells.

5. The solid-state battery according to any one of claims 1 to 4, further comprising an exterior body at least partially covering an exterior of the solid-state battery,
wherein the stress relaxation layer that relaxes stress applied to the solid-state battery is further disposed between the solid-state battery cell and the exterior body.

6. The solid-state battery according to any one of claims 1 to 5, wherein the stress relaxation layer is disposed at least either of between the positive electrode layer and the solid electrolyte layer or between the negative electrode layer and the solid electrolyte layer.
